(19) United States
(12) Patent Application Publication
(10) Pub. No.: US 2026/0129088 A1
(43) Pub. Date: May 7, 2026

(54) PARTITIONING LARGE-SCALE VIRTUAL ENVIRONMENTS ACROSS SERVERS

(71) Applicant: Roblox Corporation, San Mateo, CA (US)

(72) Inventors: Yifan CAI, San Mateo, CA (US); Linh Thi Xuan PHAN, San Mateo, CA (US); Andreas HAEBERLEN, San Mateo, CA (US)

(73) Assignee: Roblox Corporation, San Mateo, CA (US)

(21) Appl. No.: 19/380,168

(22) Filed: Nov. 5, 2025

Related U.S. Application Data
(60) Provisional application No. 63/716,650, filed on Nov. 5, 2024.

(51) Int. Cl. H04L 67/1001; A63F 13/352; H04L 47/125

(52) U.S. Cl. CPC H04L 67/1001; A63F 13/352; H04L 47/125

(57) ABSTRACT

Some implementations relate to methods, systems, and computer readable media for partitioning large-scale virtual environments across multiple servers. Data representing a virtual environment is received, including multiple virtual regions with associated computational and memory loads. Communication metrics between adjacent virtual regions are determined. Each virtual region is assigned to a respective server based on balancing computational and memory loads and reducing communication metrics between virtual regions assigned to different servers. The assignment of virtual regions is refined iteratively, such that virtual regions with dense interaction are grouped together on a common server to reduce inter-server communication. State data for virtual regions located at boundaries between server assignments is replicated to neighboring servers. A distributed computing infrastructure is provided for the virtual environment, configured to simulate the virtual environment based on the assignment of virtual regions to the servers.

### CROSS-REFERENCE TO RELATED APPLICATIONS

This application claims priority under 35 U.S.C. § 119(e) to U.S. Provisional Patent Application No. 63/716,650, filed November 5, 2024, and titled “PARTITIONING LARGE-SCALE VIRTUAL ENVIRONMENTS ACROSS SERVERS,” the entire contents of which are incorporated by reference herein.

### TECHNICAL FIELD

This document relates generally to distributed virtual environments, and more particularly but not exclusively, relates to methods, systems, and computer-readable media to partition large-scale virtual environments across multiple servers.

### BACKGROUND

The development of distributed virtual environments, for example in large-scale gaming, has brought numerous challenges related to scalability, resource management, and user experience. With the rise of multiplayer gaming, it has become increasingly important to support hundreds or thousands of concurrent players within the same virtual experience. Traditional server architectures struggle to handle the computational demands of the environments, resulting in latency issues, bottlenecks, and an inconsistent gaming experience. The problem becomes even more pronounced in scenarios where players congregate in specific areas, leading to an uneven distribution of computational load across servers.

Current methods for distributing the computational load of virtual environments involve static partitioning, wherein different sections of the game world are assigned to specific servers. Although static partitioning can initially balance the workload, it fails to adapt to the dynamic nature of player interactions (interactions between avatars associated with different players, where the avatars are in the virtual environment)) and movement within the virtual space. Players (e.g., avatars associated with players) tend to move unpredictably, and high concentrations in areas can quickly overwhelm the servers responsible for those virtual regions. As a result, performance degrades, with increased lag and reduced responsiveness, which severely affects the quality of the gaming experience.

For example, a virtual environment may be divided into three partitions, each managed by a separate server. Each server is responsible for computing and rendering its assigned portion of the map, in order to reduce computational load and improve scalability. The approach has significant limitations that prevent it from being an advantageous solution. The approach attempts to support load balancing of computation and memory across servers, which increases utilization and aims to make better use of available resources, resulting in higher performance and/or reduced costs. Each server is assigned a subset of the virtual environment, so that no single server becomes a bottleneck due to uneven load distribution. The approach leads to suboptimal partitioning, where some servers may still become overloaded due to unanticipated player density or behavior.

While maintaining timing guarantees for quality of service (QoS) is an important objective, especially in multiplayer environments where latency directly impacts user experience, the partitioning approach struggles with minimizing (or otherwise reducing) communication latency between servers. This can result in poor synchronization and reduced responsiveness for users interacting within the virtual environment, such as when players move across partition boundaries managed by different servers.

Some approaches employ dynamic load balancing techniques to adjust the allocation of resources across servers. The approaches, while an improvement over static partitioning, still face significant limitations. Dynamic load balancing techniques are reactive rather than proactive, redistributing load after performance has begun to degrade. Such reactive strategies insufficiently address temporary disruptions or latency spikes, leading to a poor user experience. Furthermore, the approaches frequently lack fine-grained control over player interactions across partition boundaries, leading to additional latency when players cross from one server's domain to another.

Another shortcoming in existing solutions is the inefficient handling of communication across server partitions. When adjacent virtual regions are assigned to different servers, the inter-server communication overhead can become a bottleneck, such as in areas of the virtual environment with high player density and frequent interactions. Traditional graph partitioning techniques used to divide the virtual space fail to account for the unique characteristics of gaming workloads, such as high-density hotspots and rapidly shifting user (e.g., player) behaviors. This can lead to inefficient partition boundaries that increase the number of cross-server communications, degrading performance and involving frequent adjustments to maintain service quality.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Various implementations described herein relate to methods, systems, and computer-readable media to partition large-scale virtual environments across multiple servers.

According to one aspect, a computer-implemented method includes receiving data representing a virtual environment including a number of virtual regions, each virtual region being associated with a computational load and a memory load. The computer-implemented method further includes determining communication metrics between adjacent virtual regions of the number of virtual regions, wherein avatars within two adjacent virtual regions can move directly between the two adjacent virtual regions. The computer-implemented method further includes assigning each virtual region to a respective server of a number of servers, where the assigning is based on: balancing the computational load and memory load among the number servers, and reducing communication metrics between virtual regions assigned to different servers. The computer-implemented method further includes refining the assignment of virtual regions to servers iteratively, such that virtual regions with dense interaction are grouped together on a common server to reduce inter-server communication. The computer-implemented method further includes replicating, based on the refined assignment, state data of virtual regions located at boundaries between server assignments to neighboring servers to enable migration of workload across servers. The computer-implemented method further includes providing a distributed computing infrastructure for the virtual environment using the refined assignment, the distributed computing infrastructure including the number of servers and configured to simulate the virtual environment based on the assignment of virtual regions to the respective servers.

In some implementations, assigning each virtual region to the respective server is further based on predicting computational and memory loads for each virtual region based on historical telemetry data for the virtual environment.

In some implementations, determining the communication metrics includes calculating a communication frequency between adjacent virtual regions based on player interactions and proximity of avatars within each of the adjacent virtual regions.

In some implementations, refining the assignment of virtual regions to servers includes expanding one or more of the virtual regions using a greedy policy that prioritizes virtual regions with lower computational and memory loads for expansion.

In some implementations, assigning the virtual regions to servers is adjusted dynamically based on avatar density in the number of virtual regions and server resource availability.

In some implementations, each virtual region is initially assigned to a server based on local hotspots of avatar activity to enable areas to be included within a single server assignment.

In some implementations, the communication metrics include at least one of a weighted combination of avatar handoffs, chat messages, and shared object interactions between adjacent virtual regions.

In some implementations, refining the assignment of virtual regions to servers includes performing iterative adjustments using graph partitioning techniques that penalize high inter-region communication cost and reward balanced server utilization.

In some implementations, replicating state data includes selectively duplicating dynamic entity data, excluding static terrain or environmental assets.

In some implementations, providing the distributed computing infrastructure includes monitoring server performance metrics and triggering re-assignment of virtual regions based on threshold breaches in latency or resource consumption.

According to another aspect, a system includes one or more processors, and memory coupled to the one or more processors with instructions stored thereon that, when executed by the one or more processors, cause the one or more processors to perform or control performance of operations including receiving data representing a virtual environment including a number of virtual regions, each virtual region being associated with a computational load and a memory load. The instructions cause the one or more processors to perform or control performance of a further operation including determining communication metrics between adjacent virtual regions of the number of virtual regions, wherein avatars within two adjacent virtual regions can move directly between the two adjacent virtual regions. The instructions cause the one or more processors to perform or control performance of a further operation including assigning each virtual region to a respective server of a number of servers, where the assigning is based on: balancing the computational load and memory load among the number servers, and reducing communication metrics between virtual regions assigned to different servers. The instructions cause the one or more processors to perform or control performance of a further operation including refining the assignment of virtual regions to servers iteratively, such that virtual regions with dense interaction are grouped together on a common server to reduce inter-server communication. The instructions cause the one or more processors to perform or control performance of a further operation including replicating, based on the refined assignment, state data of virtual regions located at boundaries between server assignments to neighboring servers to enable migration of workload across servers. The instructions cause the one or more processors to perform or control performance of a further operation including providing a distributed computing infrastructure for the virtual environment using the refined assignment, the distributed computing infrastructure including the number of servers and configured to simulate the virtual environment based on the assignment of virtual regions to the respective servers.

In some implementations, assigning each virtual region to the respective server is further based on predicting computational and memory loads for each virtual region based on historical telemetry data for the virtual environment.

In some implementations, determining the communication metrics includes calculating a communication frequency between adjacent virtual regions based on player interactions and proximity of avatars within each of the adjacent virtual regions.

In some implementations, refining the assignment of virtual regions to servers includes expanding one or more of the virtual regions using a greedy policy that prioritizes virtual regions with lower computational and memory loads for expansion.

In some implementations, assigning the virtual regions to servers is adjusted dynamically based on avatar density in the number of virtual regions and server resource availability.

According to another aspect, a non-transitory computer-readable medium includes instructions stored thereon that, when executed by a processor, cause the processor to perform or control performance of operations including receiving data representing a virtual environment including a number of virtual regions, each virtual region being associated with a computational load and a memory load. The instructions cause the one or more processors to perform or control performance of a further operation including determining communication metrics between adjacent virtual regions of the number of virtual regions, wherein avatars within two adjacent virtual regions can move directly between the two adjacent virtual regions. The instructions cause the one or more processors to perform or control performance of a further operation including assigning each virtual region to a respective server of a number of servers, where the assigning is based on: balancing the computational load and memory load among the number servers, and reducing communication metrics between virtual regions assigned to different servers. The instructions cause the one or more processors to perform or control performance of a further operation including refining the assignment of virtual regions to servers iteratively, such that virtual regions with dense interaction are grouped together on a common server to reduce inter-server communication. The instructions cause the one or more processors to perform or control performance of a further operation including replicating, based on the refined assignment, state data of virtual regions located at boundaries between server assignments to neighboring servers to enable migration of workload across servers. The instructions cause the one or more processors to perform or control performance of a further operation including providing a distributed computing infrastructure for the virtual environment using the refined assignment, the distributed computing infrastructure including the number of servers and configured to simulate the virtual environment based on the assignment of virtual regions to the respective servers.

In some implementations, assigning each virtual region to the respective server is further based on predicting computational and memory loads for each virtual region based on historical telemetry data for the virtual environment.

In some implementations, determining the communication metrics includes calculating a communication frequency between adjacent virtual regions based on player interactions and proximity of avatars within each of the adjacent virtual regions.

In some implementations, refining the assignment of virtual regions to servers includes expanding one or more of the virtual regions using a greedy policy that prioritizes virtual regions with lower computational and memory loads for expansion.

In some implementations, assigning the virtual regions to servers is adjusted dynamically based on avatar density in the number of virtual regions and server resource availability.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of the disclosure.

### BRIEF DESCRIPTION OF THE DRAWINGS

FIG. 1 is a diagram of an example system architecture in which the partitioning of large-scale gaming experiences across multiple servers can be performed, in accordance with some implementations.

FIG. 2 is a flow diagram illustrating an example method to partition large-scale virtual environments across multiple servers, in accordance with some implementations.

FIG. 3 illustrates an example comparing two partitioning approaches to distribute virtual regions of a virtual environment among multiple servers, in accordance with some implementations.

FIG. 4 illustrates an example of a communication-centric expansion policy, in accordance with some implementations.

FIG. 5 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation”, “an implementation”, “an example implementation”, “some implementations”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

One or more implementations described herein relate to managing distributed computing workloads in a virtual environment using a virtual region partitioning approach guided by load balancing and communication cost reduction. The virtual environment is represented as a set of virtual regions, each associated with respective computational and memory loads. Each region can directly border others, and avatars can transition between them during runtime. Assignments of regions to servers are computed based on the goal of balancing load across available resources while reducing communication metrics across partition boundaries.

Assignments are refined through an iterative process that evaluates communication density between adjacent regions and reassigns them to promote localized interaction within the same server boundary. The refinement favors grouping regions with high interactivity, such as frequent avatar transitions or dense collaborative activity. In some implementations, a greedy expansion strategy is used to grow partitions outward from lower-load regions while considering adjacency and connectivity patterns.

To support seamless cross-region interactions, state data for regions located at partition boundaries is replicated to adjacent servers. The replication enables predictive synchronization of state information, which supports latency reduction during real-time or near-real-time movement of avatars across regions. The approach selectively replicates dynamic state while excluding static assets or other non-volatile data, conserving bandwidth and storage while supporting responsiveness.

The resulting partition-aware infrastructure enables scalable and low-latency deployment of large interactive environments. Virtual region assignments are responsive to changing avatar density and available server resources, with updates occurring dynamically based on telemetry or performance metrics.

Some technical advantages of various features include the ability to reduce latency and improve responsiveness in large-scale virtual environments by minimizing or otherwise reducing inter-server communication. By computing communication metrics between adjacent virtual regions and grouping high-interaction regions together on the same server, the techniques reduce the need for cross-server messaging. This enables faster synchronization of avatar state and actions, such as, for example, in gameplay scenarios where multiple users interact closely or frequently transition between regions.

Another technical advantage of some implementations is dynamic scalability of server workloads based on both computational and memory demands. The assignment of virtual regions to servers is informed by real-time, near-real-time, or historical telemetry data that reflects resource usage and avatar density. This permits fine-grained, data-driven distribution of workload across multiple servers, reducing the risk of performance bottlenecks or server overutilization. As a result, the distributed computing infrastructure can accommodate fluctuating activity patterns without degrading the user experience.

A further technical advantage of certain features is the replication of state data for virtual regions near partition boundaries. This enables predictive migration and synchronized execution of avatar movement between servers. By replicating transient state data rather than static assets, the approach minimizes or otherwise reduces data redundancy while maintaining consistency and responsiveness. It supports seamless cross-server transitions without involving expensive full handoff procedures, which can interrupt or delay user actions.

Some implementations provide a technical benefit by enabling iterative refinement of region partitions using greedy expansion. Greedy expansion techniques selectively expand low-load partitions toward adjacent high-interaction areas, improving locality while respecting server resource constraints. The refinement supports adaptive load balancing that accounts for both spatial topology of the virtual world and behavioral clustering of avatars. This enhances server efficiency while maintaining logical and experiential coherence within each partition.

Another technical advantage of the described techniques is the ability to initialize partition assignments based on known hotspots of avatar activity. The approach front-loads partitioning decisions using observed behavioral patterns, enabling initial deployment configurations to reflect actual usage rather than arbitrary spatial divisions. This leads to fewer migrations and less frequent rebalancing operations, further enhancing runtime stability and reducing overhead.

Another technical advantage of the described techniques is that the partition-aware infrastructure supports modular deployment and maintenance of the virtual environment. Because region assignments and communication metrics are explicitly defined and stored, changes to topology, content, or server configurations can be simulated and evaluated prior to runtime. This enables developers and operators to make informed decisions about scaling, rebalancing, or restructuring the environment without disrupting live user sessions.

### System Architecture

The present disclosure is directed towards, inter alia, techniques to dynamically partition large-scale virtual environments (e.g., gaming experiences hosted across multiple servers) by improving the allocation of computational resources, reducing inter-server communication, and using state replication to enable smooth transitions and enhance responsiveness in distributed gaming platforms.

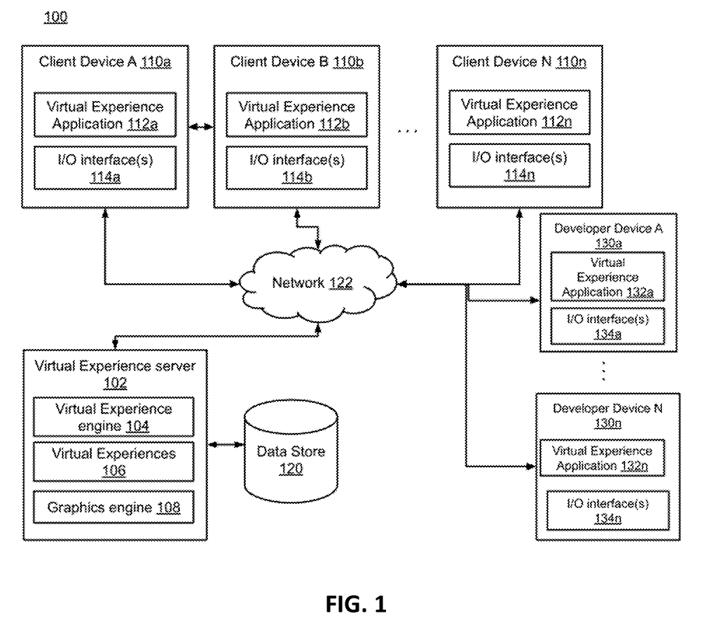

FIG. 1 is a diagram of an example system architecture 100 in which the partitioning of large-scale gaming experiences across multiple servers can be performed. FIG. 1 and the other figures use like reference numerals to identify similar elements. A letter after a reference numeral, such as “110," indicates that the text refers specifically to the element having that particular reference numeral. A reference numeral in the text without a following letter, such as "110," refers to any or all of the elements in the figures bearing that reference numeral (e.g. "110" in the text refers to reference numerals “110a," “110b," and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client device(s) 110 and developer device(s) 130 may refer to the same or same type of device.

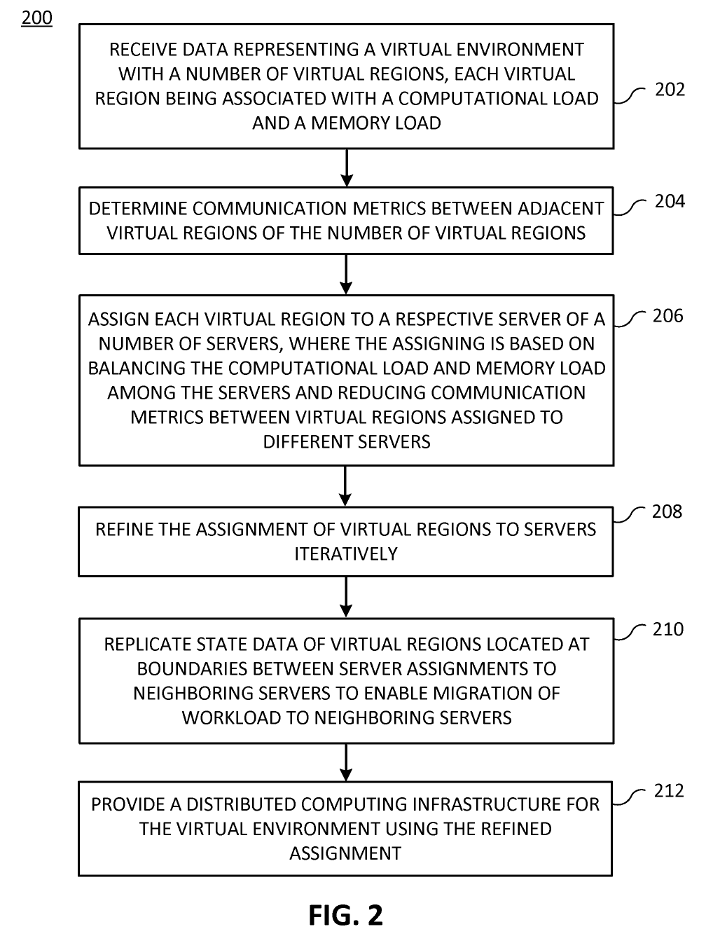

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 and/or other component(s) of the server 102 may perform one or more of the operations described below in connection with the flowchart shown in FIG. 2 or other operations/methods described herein. In one or more additional or alternative implementations, the operations described below may be performed on one or more client devices 110, or one or more developer devices 130. In some implementations, where the operations are performed depends at least in part on computational resources (e.g., memory, processing power, or disk space). A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., ethernet network), a wireless network (e.g., an 802.11 network, a Wi-Fi® network, or wireless LAN (WLAN)), a cellular network (e.g., a 5G network, a long term evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may include multiple storage components (e.g., multiple drives or multiple databases) that may span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata (e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.).

In some implementations, online virtual experience server 102 may be a type of social network providing connections between users or a type of user-generated content system that enables users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations of the disclosure, a “user” may be represented as a single individual. Other implementations of the disclosure may include a “user” (e.g., creating user) being an entity controlled by a set of users or an automated source. For example, a set of individual users federated as a community or group in a user-generated content system may be considered a “user.” In some contexts, a user may be a system administrator, a developer, or other entity having privileges/capabilities different than those of an end user.

In some implementations, online virtual experience server 102 may be or include a virtual gaming server. For example, the gaming server may provide single-player or multiplayer games to a community of users that may access a “system” herein that includes online gaming server 102, data store 120, and client device 110 and/or may interact with virtual experiences using client devices 110 via network 122. In some implementations, virtual experiences (including virtual realms or worlds, virtual games, other computer-simulated environments) may be 2D virtual experiences, 3D virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time or near-real-time with other users of the virtual experience. References herein to a game and related functionality are provided as examples so to illustrate and describe various features, and the various features may be adapted to other types of virtual experience environments that may not necessarily involve games.

In some implementations, virtual experience engagement may refer to the interaction of one or more participants using client devices (e.g., 110) within a virtual experience (e.g., 106) or the presentation of the interaction on a display or other I/O interface (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments”, “virtual environments”, or “virtual spaces” herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character (avatar) of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters (avatars), decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. Virtual experience engine 104 implements the techniques described herein. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 meets a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For example, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a character (e.g., avatar) of the user within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character (e.g., dimensions (height, width, girth, etc.); body type; movement style; number/ type of body parts; proportion (e.g., shoulder and hip ratio); head size; etc.).

One or more characters (also referred to as an “avatar” or “model” herein) may be associated with a user where the user may control the character to enable an interaction of the user with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types (e.g., shirts, pants, etc.), the online virtual experience platform may provide users access to simplified 3D virtual object models that are represented by a mesh of a low polygon count (e.g., between about 20 and about 30 polygons).

In some implementations, the user may control the scale (e.g., height, width, or depth) of a character or the scale of components of a character. In some implementations, the user may control the proportions of a character (e.g., blocky, anatomical, etc.). It may be noted that in some implementations, a character may not include a character virtual experience object (e.g., body parts, etc.) but the user may control the character (without the character virtual experience object) to enable the interaction of the user with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a character of a user for view or use by other users of the online virtual experience server 102. In some implementations, creating, modifying, or customizing characters, other virtual experience objects, virtual experiences 106, or virtual experience environments may be performed by a user using an I/O interface (e.g., developer interface) and with or without scripting (or with or without an application programming interface (API)). It may be noted that for purposes of illustration,

characters are described as having a humanoid form. It may further be noted that characters may have any form such as a vehicle, animal, animate or inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a character of a user can include a configuration of components, where the configuration and appearance of components and more generally the appearance of the character may be defined by character settings. In some implementations, the character settings of a character of a user may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that

is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the client device(s) 110 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with credentials, a virtual experience developer may obtain access to virtual experience virtual objects, such as in-platform currency (e.g., virtual currency), avatars, special powers, accessories, which are owned by or associated with other users.

In general, functions described in one implementation as being performed by the online virtual experience server 102 can be performed by the client device(s) 110, or a server or other device(s) usable in the system architecture 100, in other implementations if appropriate. In addition, the functionality attributed to a particular component can be performed by different or multiple components operating together. The online virtual experience server 102 can be accessed as a service provided to other systems or devices through suitable application programming interfaces (hereinafter “APIs”), and thus is not limited to use in websites.

In some implementations, one or more devices usable in the system architecture 100 (e.g., a virtual experience server 102) includes one or more components, such as a virtual experience engine 104 used as an example herein, that manages partitioning logic for assigning virtual regions to distributed servers. The virtual experience engine 104 performs the techniques described herein, including receiving input data representing a set of virtual regions, calculating communication metrics between adjacent regions, and generating partition assignments that balance computational and memory load while minimizing or otherwise reducing inter-server communication. The virtual experience engine 104 may implement iterative refinement policies, such as greedy expansion of partitions with lower resource usage, to group regions with dense user interaction together. The partition assignments are used to configure a distributed infrastructure in which multiple servers host and manage distinct subsets of the virtual environment.

Client devices 110 connected to the virtual environment may execute a virtual experience application 112 that interfaces with one or more servers based on the avatar's location within the partitioned regions. The application 112 processes state updates and region transitions, using replicated state data from neighboring servers to enable seamless migration of avatar control when an avatar crosses a partition boundary. In some implementations, the virtual experience application 112 maintains local state predictions or caching mechanisms for recently visited regions to support visual continuity and reduce latency during server handoff.

The virtual experience engine 104 may dynamically adjust region-to-server assignments in response to real-time or near-real-time telemetry reflecting avatar density or changes in computational load. When a region exhibits elevated user activity or increased memory consumption, the engine 104 may reassign neighboring regions or replicate state data to alleviate bottlenecks. This enables the infrastructure to adapt continually to fluctuating demands without involving disruptive architectural changes or full re-partitioning of the environment.

### Partitioning large-scale gaming experiences

FIG. 2 is a flow diagram illustrating an example method 200 to partition large-scale virtual environments across multiple servers, in accordance with some implementations.

In various implementations, the blocks shown in FIG. 2 and described below may be performed by any of the computing devices illustrated in FIG. 1, for example, by one or more of client devices 110 and/or online virtual experience server 102 and/or other device(s) usable in the system architecture 100. For example, two or more client devices 110 may perform method 200, or at least one client device 110 and online virtual experience server 102 may perform method 200. In some implementations, certain blocks of method 200 may be performed by a client device 110 and other blocks of method 200 may be performed by an online virtual experience server 102.

Method 200 begins at block 202. At block 202, data representing a virtual environment including a number of virtual regions is received. Each virtual region is associated with a computational load and a memory load. The virtual environment may include a digitally simulated three-dimensional space that can be navigated or interacted with by one or more client devices. In various implementations, the environment may include, for example, terrain, structures, non-player characters (NPCs), scripts, lighting, physics constraints, and other interactive or rendered content. In some implementations, the data representing the virtual environment includes a structured mapping of discrete subdivisions, referred to as virtual regions, that partition the environment into bounded spatial zones or cells.

Each virtual region corresponds to a defined spatial extent within the coordinate space of the virtual environment. For example, in some implementations, the environment may be divided into equally sized cubic volumes, such as 32x32x32 meters, each constituting a virtual region. In some cases, regions may vary in size or shape based on the content density, gameplay requirements, or developer annotations. A region may include one or more avatars, objects, scripts, or other active components of the environment. In some implementations, adjacency relationships between regions may be represented using a grid, graph, or sparse index.

In some implementations, each virtual region is associated with a computational load value that quantifies the processing resources used to simulate and manage the entities and activities within that region. The computational load may be based on a combination of factors, including the number of active scripts, physics simulations, animation updates, logic processing tasks, etc. For example, a region including multiple avatars, dynamic physics objects, and event-driven scripts may have a higher computational load than a region with static geometry and fewer scripted behavior. In some implementations, the load values may be estimated in advance or inferred from telemetry data collected during previous simulation sessions.

In addition to computational load, each virtual region is associated with a memory load value. In some implementations, the memory load indicates the amount of memory to store data structures associated with the region, including but not limited to object meshes, textures, material parameters, spatial indices, navigation graphs, runtime state variables, etc. Memory load may include temporary buffers used during execution, such as intermediate physics state or script execution context. In some implementations, regions with high object density, complex visual assets, or in-depth environmental features may impose elevated memory requirements.

In various implementations, the computational and memory load values may be encoded as numeric scalars or multi-dimensional vectors. For example, in some implementations, computational load may be expressed in terms of floating-point operations per second (FLOPS), central processing unit (CPU) time estimates, or normalized scores on a per-frame basis. In some implementations, memory load may be measured in megabytes, cache lines, or other units relevant to the target execution architecture. In some implementations, load values may be stored as part of a metadata structure indexed by region identifier, enabling subsequent modules to query resource usage by region.

In some implementations, the received data may include metadata describing inter-region relationships, such as which regions are adjacent, the allowed traversal directions between regions, and metrics for avatar or object movement across region boundaries. The adjacency information enables later phases of the partitioning pipeline to reason about communication overhead, migration feasibility, and load balancing constraints. In some cases, the virtual environment data may be dynamically updated as the simulation evolves, and load estimates may be periodically recomputed or refined to reflect runtime conditions. Block 202 is followed by block 204.

At block 204, communication metrics between adjacent virtual regions of the number of virtual regions are determined, where avatars within two adjacent virtual regions can move directly between the two adjacent virtual regions. Adjacent virtual regions refer to pairs of virtual regions that are spatially contiguous or otherwise directly reachable without traversing an intermediate region. For example, in a grid-partitioned environment, each region may have up to six neighbors along the x, y, and z axes. Adjacency may be determined based on bounding volumes, region indices, or explicit region linkage data provided by the virtual environment metadata.

In some implementations, communication metrics quantify the expected volume, frequency, or cost of data exchange or coordination required when avatars or objects move between adjacent regions. The metrics may represent, for example, the number of cross-region interactions per simulation frame, the number of shared dynamic entities that span multiple regions, estimates of messaging bandwidth needed to maintain simulation consistency across region boundaries, etc. Communication metrics may be used in subsequent steps to optimize or otherwise improve region partitioning or to minimize or otherwise reduce inter-node communication when assigning regions to execution nodes.

Avatars are entities in the virtual environment that represent users or agents capable of navigation and interaction. Each avatar may have associated position, animation state, input control data, and other runtime attributes. In some implementations, avatars can move directly between adjacent regions when the spatial layout enables continual movement along valid paths without encountering loading boundaries or teleportation constraints. Direct movement implies that no intermediate server or simulation zone is traversed; the transition is handled as a local adjacency event between two spatially linked regions.

In various implementations, movement data for avatars may be sampled from, for example, historical telemetry logs, synthetic simulations, or real-time or near-real-time user sessions. The data may be analyzed to determine transition frequencies between specific pairs of regions, providing empirical support for estimating communication load. For example, if avatars frequently cross between Region A and Region B during gameplay, the communication metric between those regions may be assigned a higher value than between regions with little observed transition activity. Transition frequencies may be represented as scalar weights, directional edge costs, or normalized flow rates.

In some implementations, the determination of communication metrics may incorporate non-avatar factors. In some implementations, shared objects or collaborative gameplay mechanics may span multiple adjacent regions, such as vehicles moving between zones, scripted events triggering cross-region effects, or NPCs patrolling across boundaries. The interdependencies contribute to synchronization or coordination requirements between adjacent regions and may increase the associated communication metric values. In some cases, region-specific metadata may declare persistent inter-region links or dependencies that influence metric assignment.

In some implementations, the resulting communication metrics are stored in a matrix or graph representation, where each node corresponds to a region and each edge encodes the communication metric for a specific adjacent region pair. The matrix may be symmetric or asymmetric depending on whether directionality is modeled. For example, movement from Region A to B may occur more frequently than the reverse direction, leading to different communication values for each direction. The structured representation enables downstream modules to apply partitioning, balancing, or optimization techniques that reduce total communication cost or minimize cross-boundary interactions.

In some implementations, the determining of communication metrics includes calculating a communication frequency between adjacent virtual regions based on player interactions and proximity of avatars within each of the adjacent virtual regions. Communication frequency may represent the volume or rate of data exchanged between simulation components responsible for neighboring regions, driven by cross-region interactions of player-controlled entities. For example, when avatars in a first virtual region frequently interact (e.g., through movement, gestures, combat, or shared object manipulation) with avatars located in a directly adjacent region, the resulting simulation events may trigger increased inter-region message passing. In some implementations, the platform monitors proximity thresholds and interaction events to increment counters associated with specific region pairs, producing a time-weighted interaction density matrix. The matrix can be used to estimate relative communication frequencies among region boundaries. In some implementations, proximity is defined based on distance thresholds between avatar positions, such as spatial radii within a shared coordinate space, while interactions may include in-game mechanics such as collision, messaging, co-navigation, or shared environment triggers. The metrics may be stored and updated dynamically or extracted from historical logs for analysis prior to partition assignment.

In some implementations, the communication metrics include a weighted combination of avatar handoffs, chat messages, and shared object interactions between adjacent virtual regions. An avatar handoff may include a transfer event where an avatar moves from one virtual region to an adjacent region, requiring handoff of simulation responsibilities between servers. Chat messages are tracked when users in one region initiate communication with users in a neighboring region, which may involve cross-region data transmission. Shared object interactions refer to user interactions with virtual objects that span two or more regions, such as collaborative tools, shared vehicles, or jointly manipulated items. Each of the factors contributes to the communication cost between adjacent regions, and weighting coefficients can be applied based on expected network traffic, latency sensitivity, or gameplay design constraints. The resulting composite metric can be used to inform partitioning decisions that minimize or otherwise reduce the expected communication overhead across servers. Block 204 is followed by block 206.

At block 206, each virtual region is assigned to a respective server of a number of servers, where the assignment is based on balancing the computational load and memory load among the number of servers, and reducing values of communication metrics between virtual regions assigned to different servers. The communication metrics may be derived from quantitative measures such as avatar handoff frequency, chat volume, or shared object interactions between virtual regions. Reducing the communication metrics refers to lowering the total estimated communication overhead between servers, rather than reducing the number or types of metrics tracked. The assignment establishes a mapping of simulation responsibilities that distributes processing and memory usage across available servers while aiming to lower inter-server messaging or data synchronization arising from region-to-region interactions.

In some implementations, the computational load of a virtual region may include the processing resources to simulate the region's entities, physics, scripts, or avatar interactions per simulation frame. This may include CPU cycles to compute object trajectories, collision detection, animation updates, artificial intelligence (AI) behaviors within the region, etc. The computational load can be estimated based on historical profiling data, heuristic models, or real-time or near-real-time measurement of execution duration associated with simulation routines per region.

The memory load of a virtual region may include the amount of volatile storage required to maintain its runtime state, which may include object attributes, avatar states, terrain data, active scripts, metadata, etc. In some implementations, memory load may account for transient allocations such as particle effects or temporary buffers generated during gameplay. Both computational and memory loads may be represented as scalar quantities associated with each region and aggregated across assigned regions when evaluating server assignments.

In some implementations, the server assignment logic evaluates all candidate mappings of regions to servers using a cost function that combines load balancing and communication metric-based cost. Load balancing may be evaluated using metrics such as the standard deviation of total computational or memory loads across servers, or load balancing may be performed so that each server remains below a target threshold. The communication cost may be computed by summing communication metrics for adjacent region pairs that are assigned to different servers. The assignment with the lowest total cost, or one that meets predefined constraints, may be selected.

In some implementations, graph-partitioning techniques are applied to the region adjacency graph described earlier, where edge weights correspond to communication metrics and node weights correspond to region load values. In some implementations, techniques such as multilevel k-way partitioning or spectral clustering may be used to divide the graph into region groupings that reduce inter-server communication while maintaining balanced load distribution. Each grouping corresponds to a set of regions assigned to the same server.

In some implementations, the assignment may be recomputed periodically (or otherwise repeatedly) or incrementally adjusted in response to changes in runtime conditions, such as the entry of additional avatars into the virtual environment or evolving simulation complexity. The assignment result may be stored in a mapping table or region directory, which specifies the server responsible for each region and is used by routing, rendering, or synchronization components. The resulting assignment may be broadcast to participating servers to establish communication pathways and coordination responsibilities.

In some implementations, the assigning of virtual regions to the respective servers is further based on predicting computational and memory loads for each virtual region based on historical telemetry data for the virtual environment. The historical telemetry data is collected during previous executions of the virtual environment. In various implementations, the telemetry data may include records of, for example, avatar density, interaction frequencies, triggered simulation events, environmental complexity, usage patterns over time, etc. A load estimation module may analyze the data to compute expected CPU utilization, memory footprint, and resource variability for each region. The predicted computational and memory loads are used as input to the assignment selection process, which allocates virtual regions to servers in a manner that accounts not only for current resource demands but also for expected fluctuations. In some implementations, predictive modeling techniques such as moving averages, weighted trend analysis, or statistical profiling may be used to determine anticipated load values for each region prior to assignment.

In some implementations, the assigning of virtual regions is adjusted dynamically based on avatar density in the number of virtual regions and server resource availability. Dynamic adjustment includes real-time or near-real-time reassignment of regions to different servers as conditions within the virtual environment evolve. Avatar density may be measured as the number of avatars present per unit area or per region, with higher densities indicating concentrated player activity that may increase both computational and communication loads. In such cases, regions experiencing surges in density may be migrated to less loaded servers to maintain balanced utilization. In some implementations, server resource availability is monitored continually to track CPU usage, memory capacity, and network throughput. When a threshold imbalance is detected, such as a server exceeding a defined utilization limit, the assignment logic reassigns one or more regions to neighboring servers with available capacity. In some implementations, migration policies account for region adjacency, minimizing or otherwise reducing disruption by prioritizing reassignment of peripheral regions near assignment boundaries, and may employ predictive thresholds to anticipate high-density events before they cause performance degradation.

In some implementations, each virtual region is initially assigned based on local hotspots of avatar activity to enable areas to be included within a single server assignment. A hotspot includes a spatial zone within the virtual environment exhibiting a high frequency of avatar presence or interaction over a defined period. The assignment technique uses telemetry data to identify spatial concentrations of player movement, communication, or in-game interactions such as combat, trade, or collaborative events. Assigning regions with localized activity to the same server reduces inter-server communication during early stages of environment initialization and minimizes or otherwise reduces cross-partition state synchronization. In some implementations, hotspot detection is performed using sliding windows over movement logs or activity heatmaps, enabling the assignment logic to map contiguous zones of elevated activity to a single server during the initial region-to-server mapping phase. Block 206 is followed by block 208.

At block 208, the assignment of virtual regions to servers is refined iteratively, such that virtual regions with dense interaction are grouped together on a common server to minimize or otherwise reduce inter-server communication. The refinement step operates on an initial partitioning of virtual regions to servers, adjusting the assignments such that virtual regions with high levels of cross-region interaction are co-located under the same server. The objective of the refinement is to reduce the frequency and volume of inter-server communication that would otherwise be used to synchronize shared states or manage avatar transfers across server boundaries.

Interaction density includes a quantified measure of activity between pairs of virtual regions. In some implementations, interaction density may be computed based on metrics such as the number of avatars crossing between regions within a time window, the number of shared simulation dependencies (e.g., objects interacting across region borders), or the volume of communication messages exchanged due to cross-region interactions. The interaction density may be normalized over time to account for temporal fluctuations in activity.

Adjacent virtual regions that exhibit a high interaction density may be classified as densely interacting. In some implementations, a threshold-based policy is used to classify region pairs: if the interaction density exceeds a predefined threshold, the pair is considered dense. The dense pairs are candidates for co-location on the same server to minimize or otherwise reduce inter-region communication metrics. The co-location decision may factor in the current server utilization distribution to ensure utilization constraints are not violated.

In some implementations, the refinement process is iterative and may involve applying local adjustments such as swapping two regions between servers, migrating a single region, or merging region clusters. Each iteration evaluates whether the proposed adjustment reduces a cost function that jointly models inter-region communication metrics and server utilization. The refinement process may continue until a convergence condition is met, such as no further cost improvement or a maximum number of iterations.

To support refinement decisions, a region interaction graph may be maintained, where each node represents a region and each edge represents interaction density between regions. In some implementations, the refinement process operates as a clustering or community detection operation on the graph, attempting to identify tightly connected subgraphs that can be mapped to the same server without violating utilization constraints.

In some implementations, runtime telemetry is collected to update interaction density values over time. The refinement process may be executed periodically or otherwise repeatedly during low-load intervals or triggered reactively in response to significant changes in avatar distribution or interaction patterns. The resulting region-to-server mapping may be propagated to relevant routing components, and in cases involving region reassignment, session migration protocols may be invoked to transfer simulation responsibilities to the new server.

In some implementations, refining the virtual region partitions includes expanding one or more of the virtual regions using a greedy policy that prioritizes virtual regions with lower computational and memory loads for expansion. A greedy policy may include a heuristic-driven expansion approach in which decisions are made iteratively based on locally optimal choices at each step, without backtracking. For example, during partition refinement, a virtual region may be selected as a candidate for expansion if its current resource consumption is below a predefined threshold, and if expansion into an adjacent region is expected to reduce inter-region communication while maintaining balanced server utilization. In some implementations, the greedy expansion selects regions with minimal or relatively fewer current resource usage and evaluates adjacent regions for potential inclusion, provided such inclusion does not violate upper bounds for server utilization or increase inter-region communication costs. The expansion process may iterate over the virtual environment map, reassigning boundary regions to existing partitions, thereby forming larger contiguous zones that maintain internal interaction density and reduce boundary traffic. The refinement may be applied after an initial assignment phase or during runtime rebalancing.

In some implementations, refining the virtual region partitions includes performing iterative adjustments using graph partitioning techniques that penalize high inter-region communication cost and reward balanced server utilization. The virtual regions and their connectivity relationships are represented as a graph structure, where nodes correspond to virtual regions and weighted edges represent inter-region communication metrics between adjacent regions. The graph partitioning techniques operate to divide the graph into subsets corresponding to server assignments. A cost function is applied that penalizes edges with high communication weights crossing between partitions (representing inter-server communication overhead) and simultaneously rewards configurations where the aggregate computational and memory loads are evenly distributed across partitions. The refinement proceeds through multiple passes, where each pass re-evaluates potential partition boundary changes and updates the graph structure accordingly. The approach enables the partitioning to converge toward a state that aligns with inter-region communication minimization and balanced server utilization objectives. Block 208 is followed by block 210.

At block 210, state data of virtual regions located at boundaries between server assignments is replicated to neighboring servers to enable migration of workload across servers. The replication enables each server to maintain partial awareness of the simulation states occurring immediately outside its assigned region set, thereby supporting migration of simulation responsibilities, maintaining consistency during cross-server interactions, and minimizing or otherwise reducing inter-server communication delays for avatars transitioning between regions.

In this context, state data includes the computational representation of simulation entities within a region. This may include positional and behavioral attributes of avatars, dynamic or static objects, environment state variables (e.g., weather conditions or destructible terrain), metadata such as timestamps or version identifiers, etc. The replicated state may be a subset of the full region state, such as elements for predictive updates, interpolation, migration handling, etc.

Virtual regions are considered adjacent if they share a border along at least one spatial axis and support direct avatar movement across that boundary. In some implementations, adjacency is determined by grid topology, such that neighboring grid cells are marked as adjacent. In other implementations, adjacency is defined by proximity metrics or explicit navigation pathways defined in the virtual environment configuration. Regions assigned to different servers but marked as adjacent are termed inter-server adjacent regions for purposes of replication.

In some implementations, replication includes transmitting a consistent snapshot of state data from the owning server of a region to the servers managing neighboring regions. The snapshots may be generated at a fixed frame rate or based on event triggers (e.g., significant change to an object near the border). Delta encoding or selective filtering may be used to limit replication volume (e.g., replicating avatars or objects within a defined distance from the region border).

In some implementations, the receiving server stores the replicated state data in a non-authoritative buffer, which may be used for rendering predictions, migration readiness, or interaction handling. In some implementations, servers use the data to instantiate predictive simulations of incoming avatars or apply pre-warming techniques to reduce cold-start latency if ownership of a region or entity is transferred. The replicated state may assist with collision resolution or visual continuity across region boundaries.

In some implementations, replicated state data is tagged with consistency metadata to indicate staleness or update validity. Servers may discard expired replicated data or apply smoothing techniques to reconcile differences during migration. In implementations involving server fault tolerance or redundancy, the replicated border state may serve as a basis for reassigning ownership during failover or load balancing events, providing continuity of simulation for active entities near region boundaries.

In some implementations, replicating state data includes selectively duplicating dynamic entity data, excluding static terrain or environmental assets. Dynamic entity data may refer to state variables representing time-varying entities such as avatars, non-player characters, physics-simulated objects, or any runtime-modified element within a virtual region. The dynamic entities require synchronized updates when a migration event occurs between neighboring servers, such as during a region handoff. Static assets, such as terrain meshes, environmental textures, lighting probes, and immobile structures, may not be duplicated across servers, as the elements are either shared globally or can be preloaded independently of the partitioning. The selective replication reduces unnecessary memory and network overhead by limiting cross-server duplication to entities whose state requires consistency across server-assigned region boundaries. The replicated dynamic state data may be stored in a transient cache accessible to the server responsible for the adjacent region to enable smooth migration of entities across server boundaries. Block 210 is followed by block 212.

At block 212, a distributed computing infrastructure for the virtual environment is provided. The distributed computing infrastructure includes the number of servers, and is configured to simulate the virtual environment based on the assignment of virtual regions to the respective servers. The infrastructure includes a number of distinct server nodes, each configured to handle simulation workloads associated with one or more assigned virtual regions. The infrastructure enables concurrent execution of region-specific simulations, data replication across server-assigned region boundaries, and dynamic redistribution of workloads when conditions change.

In some implementations, the distributed computing infrastructure includes an orchestration component responsible for deploying simulation services across the participating servers. In some implementations, each server hosts one or more runtime instances responsible for simulating assigned virtual regions using region-specific state data, simulation logic, and interaction rules. The infrastructure may include monitoring services, load-tracking components, and data exchange layers to support replication and messaging between servers.

In some implementations, partition assignments determined during earlier blocks are used to define which server is responsible for which region. The assignments may be encoded in a partition map or routing table distributed to all nodes participating in the infrastructure. Servers use the information to route avatar movement, synchronize interactions across borders, and process global queries involving multiple regions. For example, when an avatar crosses from region A to region B, the infrastructure coordinates the handoff between the servers assigned to those regions using the partition assignments.

In some implementations, partition assignments are stored in a shared registry or distributed metadata service, which enables clients and ancillary services to query server-region mappings. This supports consistent routing of inputs and efficient resolution of inter-region dependencies. In some implementations, the infrastructure provides support for hot reconfiguration, enabling partitions to be reassigned in response to load conditions without halting the simulation.

In some implementations, each server in the distributed computing infrastructure may include a communication module for exchanging updates with other servers. The updates may include replicated state data from adjacent regions (as described in block 210), movement notifications for avatars crossing region boundaries, changes to shared environmental variables, etc. In some implementations, servers coordinate using a message-passing protocol or a shared publish-subscribe mechanism to propagate region-level state changes and maintain consistency across partition boundaries.

In some implementations, the infrastructure supports distributed debugging, logging, or analytics collection by assigning region-specific identifiers to logs, traces, and telemetry streams. This enables operators to correlate performance or error metrics with specific partitions and server assignments. In some implementations, the distributed infrastructure may support snapshotting or backup mechanisms for preserving region state and enabling recovery in the event of server failure or reassignment.

In some implementations, the providing of the distributed computing infrastructure includes monitoring server performance metrics and triggering re-partitioning based on threshold breaches in latency or resource consumption. In various implementations, performance metrics may include server-side measurements such as, for example, frame latency, memory usage, CPU utilization, network throughput, etc. Each server in the distributed computing infrastructure may report the metrics at regular intervals or upon event triggers. A centralized or decentralized controller may compare the reported values to predefined thresholds, such as maximum acceptable frame time or resource saturation levels. If one or more metrics exceed their respective thresholds, a re-evaluation of the current partition assignments may be triggered. In response, the partitioning logic may initiate a rebalancing phase that reassigns virtual regions to alternative servers in order to redistribute computational and memory load. The re-partitioning process may be executed incrementally or with a staged handoff protocol to avoid interrupting ongoing simulation activities.

In some implementations, one or more of blocks 202-212 may be performed by one or more server devices, and one or more of blocks 202-212 may be performed by one or more client devices. In some implementations, all of method 200 may be performed by a server device, or by a client device. In some implementations, one or more of blocks 202-212 may be performed in parallel. According to various implementations, blocks may be added, deleted, modified, combined, supplemented with other blocks, performed in a different order than as shown and described, performed in parallel, and so forth.

Some implementations described herein may utilize user-related data, such as historical telemetry data capturing avatar movement across virtual regions, frequency of interactions between avatars, or resource usage statistics associated with user sessions. In such implementations, user-related data is collected with explicit user consent and in accordance with applicable privacy regulations. When collected, such data is used solely for partitioning optimization and server load prediction purposes as permitted by the user. Personally identifiable information is excluded from datasets used in modeling or decision logic, retaining only aggregated and anonymized metrics required for operational functions such as predictive load balancing or interaction-based region assignment. Data retention is time-limited and subject to periodic deletion schedules. Users may be provided with configurable controls to manage whether their data is collected, how it is processed, and to request deletion of previously collected data.

In various implementations, the techniques described herein may include combinations of one or more features recited in the claims. For example, in some implementations, data representing a virtual environment comprising a plurality of virtual regions is received, where each virtual region is associated with a computational load and a memory load. Communication metrics between adjacent virtual regions are determined, where avatars within the adjacent virtual regions can move directly between them. Each virtual region is assigned to a respective server of a plurality of servers, based on balancing the computational and memory loads among the servers and reducing communication metrics between virtual regions assigned to different servers. The assignment is refined iteratively to group virtual regions with dense interaction on the same server and reduce inter-server communication. Based on the refined assignment, state data of virtual regions at boundaries between server assignments is replicated to neighboring servers to enable workload migration. A distributed computing infrastructure for simulating the virtual environment is provided, using the refined assignment of virtual regions to servers.

In some implementations, assigning each virtual region to a respective server is further based on predicting computational and memory loads using historical telemetry data for the virtual environment. In some implementations, determining the communication metrics includes calculating a communication frequency between adjacent virtual regions based on player interactions and avatar proximity. In some implementations, refining the assignment of virtual regions to servers includes expanding virtual regions using a greedy policy that prioritizes expansion of regions with lower computational and memory loads. In some implementations, the assignment of virtual regions to servers is dynamically adjusted based on avatar density and server resource availability. In some implementations, each virtual region is initially assigned to a server based on local hotspots of avatar activity to allow those areas to be included within the same server assignment. In some implementations, the communication metrics include a weighted combination of avatar handoffs, chat messages, and shared object interactions between adjacent virtual regions. In other implementations, refining the assignment includes performing iterative adjustments using graph partitioning techniques that penalize high inter-region communication cost and reward balanced server utilization. In some implementations, replicating state data includes selectively duplicating only dynamic entity data, excluding static terrain or environmental assets. In some implementations, providing the distributed computing infrastructure includes monitoring server performance metrics and triggering re-assignment of virtual regions when thresholds for latency or resource consumption are breached. Each of the foregoing features may be implemented alone or in combination with one another.

### Comparing partitioning approaches

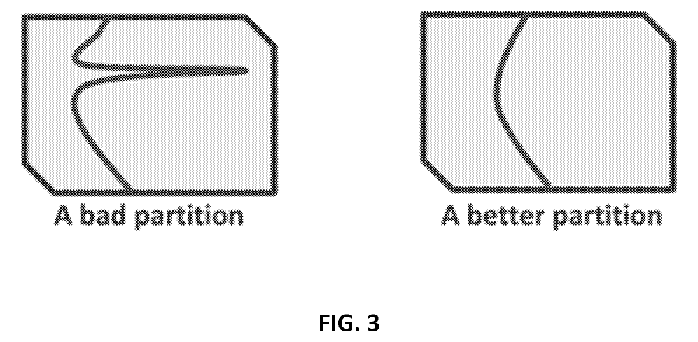

FIG. 3 illustrates an example comparing two partitioning approaches for distributing virtual regions of a virtual environment among multiple servers, in accordance with some implementations. The left diagram, labeled a "bad partition," depicts an inefficient partitioning scheme, while the right diagram, labeled a "better partition," demonstrates more effective partition refinement techniques for dividing the virtual space.

In the "bad partition" example, the borders between the virtual regions are irregular and complex, leading to significant inefficiencies. Such irregular partition boundaries result in increased cross-server communication, as players and objects move across the jagged boundaries, leading to additional overhead. The increased interaction between partitions raises the computational and network costs due to frequent state replication across servers and negatively impacts the player's experience by creating potential latency spikes. The complex borders involve more effort to replicate the state between servers, adding additional strain on computational resources.

The "better partition" example shows a partitioning scheme that maintains smooth and simplified borders. By creating well-defined and minimal or otherwise reduced partition boundaries, inter-server replication is reduced significantly, leading to a more efficient use of computational resources. The smoother partition boundaries help to localize player interactions within individual servers, reducing frequent migration events and providing for less frequent player crossing of partition boundaries. The design leads to a reduction in latency, improved server performance, and a better overall user experience.

Additionally, the effectiveness of partitioning approaches involves, in addition to minimizing or otherwise reducing border complexity, considering the forecasted load within each partition. The "better partition" scheme takes into account potential player movement and density, thereby reducing the need for future partition adjustments. By considering load forecasts, it is possible to create partitions that remain balanced even as player behavior changes over time, thus minimizing or otherwise reducing the potential need for reassignment of virtual regions and enabling stable server performance.

The partitioning approach depicted in FIG. 3 illustrates keeping partitions in reasonable shapes, which reduces the likelihood that players will move across partitions frequently. Maintaining reasonable borders helps in reducing the cost of replication and inter-server messaging. By designing partitions with future load in mind, the virtual environment can maintain a consistent and responsive user experience while managing resources more efficiently.

### Communication-centric expansion policy

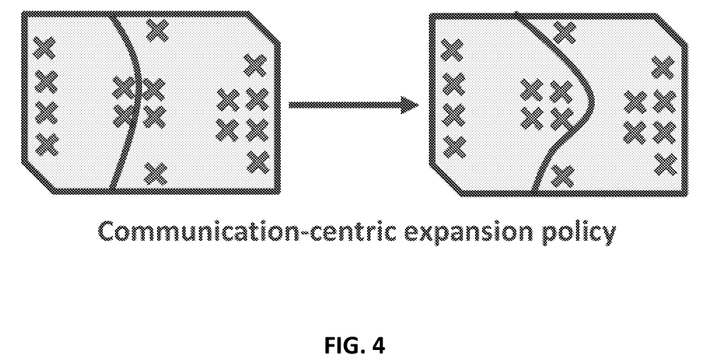

FIG. 4 illustrates an example of a communication-centric expansion policy, in accordance with some implementations.

FIG. 4 depicts two stages: on the left, the initial partition boundary is depicted, and on the right, the result after applying the expansion policy is depicted. The boundary in the illustration represents the dividing line between two partitions. The “x” marks indicate avatar position. As can be seen on the left, two avatars are present near the border in each of the partitions.

In the initial partition (left), the boundary is drawn such that several virtual regions requiring frequent interaction are divided across partitions (e.g., the two players near the border in each partition can interact frequently with the two players across the border in the other partition). The configuration increases the overhead due to cross-server communication, as each interaction across the partition boundary requires state data to be synchronized between different servers. High inter-partition communication not only degrades the performance due to increased latency but also increases computational and memory requirements as more resources are dedicated to maintaining consistency across partitions.

The communication-centric expansion policy, illustrated on the right, seeks to address the inefficiencies by adjusting the partition boundaries to include avatars with high communication within the same partition. By including the interacting avatars in the same partition, the cross-partition synchronization overhead can be significantly decreased, leading to improved server performance and reduced latency.

### Computing device

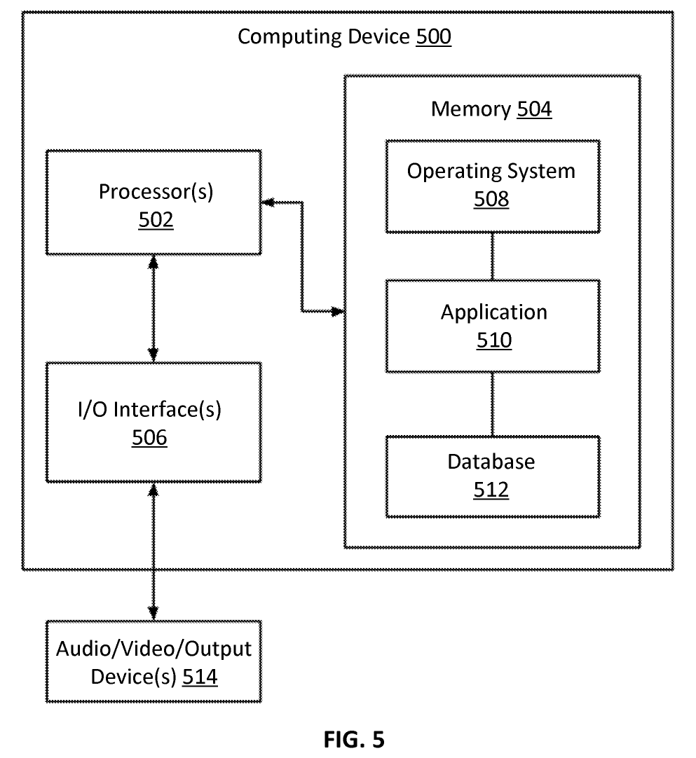

FIG. 5 is a block diagram of an example computing device 500 which may be used to implement one or more techniques described herein. In one example, device 500 may be used to implement a computer device (e.g., 102, 130, and/or 110 of FIG. 1), and perform method implementations described herein. Computing device 500 can be any suitable computer system, server, or other electronic or hardware device. For example, the computing device 500 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 500 includes a processor 502, a memory 504, input/output (I/O) interface 506, and audio/video input/output devices 514.

Processor 502 can be one or more processors and/or processing circuits to execute program code and control basic operations of the device 500. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “near-real-time”, “offline,” in a “batch mode,” etc. Portions of processing may be performed at different times and at different locations, by different (or the same) processing systems. A computer may be any processor in communication with a memory.

Memory 504 is provided in device 500 for access by the processor 502, and may be any suitable computer-readable or processor-readable storage medium, e.g., random access memory (RAM), read-only memory (ROM), electrical erasable read-only memory (EEPROM), flash memory, etc., suitable for storing instructions for execution by the processor, and located separate from processor 502 and/or integrated therewith. Memory 504 can store software operating on the server device 500 by the processor 502, including an operating system 507, one or more applications 510, and a database 512 that may store data used by the components of device 500.

Database 512 may store one or more mechanisms, including partition assignments, computational load metrics, configurations for managing virtual regions in a distributed virtual environment, etc. In some implementations, database 512 may store information associated with virtual regions, such as unique identifiers for each virtual region, metadata describing their computational and memory requirements, and data representing communication metrics between virtual regions. The stored data can include, for example, historical load records, partition boundary configurations, forecasted load estimates used during partition adjustments, etc. For example, in a large-scale gaming environment, the database might store current partition assignments and their respective communication metrics, indicating how server assignments and player density influenced resource usage. In some implementations, database 512 may store other data relevant to partition management, such as replication checkpoints, configurations for expansion policies, and session information for managing partition adjustments across multiple servers. Applications 510 can include instructions that enable processor 502 to execute or control execution of the described techniques, such as load balancing, adjusting partition boundaries, and managing communication-centric expansion policies.

For example, one or more applications 510 can include a module that implements one or more techniques or services described herein, such as adjusting partition boundaries based on real-time or near-real-time load metrics, managing replication of state data across server borders, integrating server-specific resource constraints into partition adjustments, etc. Applications 510 can incorporate real-time or near-real-time updates that monitor the distribution of computational and memory loads, enabling the load of each server to remain balanced and communication overhead to be minimized or other reduced. The applications 510 may employ various mechanisms to refine partitioning, including adjusting boundaries based on predicted player density, determining expansion priorities, and applying context-based rules for virtual region grouping. The application(s) 510 may be used to implement the application 112, the engine(s) 104/108, application 132, and/or any other component(s) usable in the system architecture 100 of FIG. 1. Database 512 (and/or other connected storage) can store various data used in the described techniques, including virtual region identifiers, historical load records, replication configurations, and parameters for determining optimal partition adjustments based on server performance and player interactions.

Elements of software in memory 504 can alternatively be stored on any other suitable storage location or computer-readable medium. In addition, memory 504 (and/or other connected storage device(s)) can store instructions and data used in the features described herein. Memory 504 and any other type of storage (magnetic disk, optical disk, magnetic tape, or other tangible media) can be considered "storage" or "storage devices."

I/O interface 506 (which can implement the I/O interface 114/134 of FIG. 1) can provide functions to enable interfacing the computing device 500 with other systems and devices. For example, network communication devices, storage devices (e.g., memory and/or data store 120), and input/output devices can communicate via interface 506. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 514 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For ease of illustration, FIG. 5 shows one block for each of processor 502, memory 504, I/O interface 506, and software blocks of operating system 508 and virtual experience application 510. The blocks may represent one or more processors or processing circuitries, operating systems, memories, I/O interfaces, applications, and/or software engines. In other implementations, device 500 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, client device 110, or similar system, or any suitable processor or processors associated with such a system, may perform or control performance of the operations described.

Device 500 can be a server device or client device. Example client devices or user devices can be computer devices including some similar components as the device 500 (e.g., processor(s) 502, memory 504, and I/O interface 506). An operating system, software and applications suitable for the client device can be provided in memory and used by the processor. The I/O interface for a client device can be connected to network communication devices, as well as to input and output devices (e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices). A display device within the audio/video input/output devices 514, for example, can be connected to (or included in) the device 500 to display images pre- and post-processing as described herein, where such display device can include any suitable display device (e.g., a liquid-crystal display (LCD), light-emitting diode (LED), or plasma display screen, cathode ray tube (CRT), television, monitor, touchscreen, 3-D display screen, projector, or other visual display device). Some implementations can provide an audio output device (e.g., voice output or synthesis that speaks text).

One or more methods described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), for example, a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be included in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, for example, a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, the particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed (e.g., procedural or object-oriented). The routines may execute on a single processing device or multiple processors. Although the steps, blocks, operations, or computations may be presented in a specific order, the order may be changed in different particular implementations. In some implementations, multiple steps or operations shown as sequential in the specification may be performed at the same time.

1. A computer-implemented method comprising:
receiving data representing a virtual environment comprising a plurality of virtual regions, each virtual region being associated with a computational load and a memory load;
determining communication metrics between adjacent virtual regions of the plurality of virtual regions, wherein avatars within two adjacent virtual regions can move directly between the two adjacent virtual regions;
assigning each virtual region to a respective server of a plurality of servers, wherein the assigning is based on:
balancing the computational load and memory load among the plurality of servers, and
reducing communication metrics between virtual regions assigned to different servers;
refining the assignment of virtual regions to servers iteratively, such that virtual regions with dense interaction are grouped together on a common server to reduce inter-server communication;
replicating, based on the refined assignment, state data of virtual regions located at boundaries between server assignments to neighboring servers to enable migration of workload across servers; and
providing a distributed computing infrastructure for the virtual environment using the refined assignment, the distributed computing infrastructure comprising the plurality of servers and configured to simulate the virtual environment based on the assignment of virtual regions to the respective servers.

2. The computer-implemented method of claim 1, wherein assigning each virtual region to the respective server is further based on predicting computational and memory loads for each virtual region based on historical telemetry data for the virtual environment.

3. The computer-implemented method of claim 1, wherein determining the communication metrics comprises calculating a communication frequency between adjacent virtual regions based on player interactions and proximity of avatars within each of the adjacent virtual regions.

4. The computer-implemented method of claim 1, wherein refining the assignment of virtual regions to servers comprises expanding one or more of the virtual regions using a greedy policy that prioritizes virtual regions with lower computational and memory loads for expansion.

5. The computer-implemented method of claim 1, wherein assigning the virtual regions to servers is adjusted dynamically based on avatar density in the plurality of virtual regions and server resource availability.

6. The computer-implemented method of claim 1, wherein each virtual region is initially assigned to a server based on local hotspots of avatar activity to enable areas to be included within a single server assignment.

7. The computer-implemented method of claim 1, wherein the communication metrics comprise at least one of a weighted combination of avatar handoffs, chat messages, and shared object interactions between adjacent virtual regions.

8. The computer-implemented method of claim 1, wherein refining the assignment of virtual regions to servers comprises performing iterative adjustments using graph partitioning techniques that penalize high inter-region communication cost and reward balanced server utilization.

9. The computer-implemented method of claim 1, wherein replicating state data comprises selectively duplicating dynamic entity data, excluding static terrain or environmental assets.

10. The computer-implemented method of claim 1, wherein providing the distributed computing infrastructure comprises monitoring server performance metrics and triggering re-assignment of virtual regions based on threshold breaches in latency or resource consumption.

11. A system comprising:
one or more processors; and
memory coupled to the one or more processors with instructions stored thereon that, when executed by the one or more processors, cause the one or more processors to perform or control performance of operations comprising:
receiving data representing a virtual environment comprising a plurality of virtual regions, each virtual region being associated with a computational load and a memory load;
determining communication metrics between adjacent virtual regions of the plurality of virtual regions, wherein avatars within two adjacent virtual regions can move directly between the two adjacent virtual regions;
assigning each virtual region to a respective server of a plurality of servers, wherein the assigning is based on:
balancing the computational load and memory load among the plurality of servers, and
reducing communication metrics between virtual regions assigned to different servers;
refining the assignment of virtual regions to servers iteratively, such that virtual regions with dense interaction are grouped together on a common server to reduce inter-server communication;
replicating, based on the refined assignment, state data of virtual regions located at boundaries between server assignments to neighboring servers to enable migration of workload across servers; and
providing a distributed computing infrastructure for the virtual environment using the refined assignment, the distributed computing infrastructure comprising the plurality of servers and configured to simulate the virtual environment based on the assignment of virtual regions to the respective servers.

12. The system of claim 11, wherein assigning each virtual region to the respective server is further based on predicting computational and memory loads for each virtual region based on historical telemetry data for the virtual environment.

13. The system of claim 11, wherein determining the communication metrics comprises calculating a communication frequency between adjacent virtual regions based on player interactions and proximity of avatars within each of the adjacent virtual regions.

14. The system of claim 11, wherein refining the assignment of virtual regions to servers comprises expanding one or more of the virtual regions using a greedy policy that prioritizes virtual regions with lower computational and memory loads for expansion.

15. The system of claim 11, wherein assigning the virtual regions to servers is adjusted dynamically based on avatar density in the plurality of virtual regions and server resource availability.

16. A non-transitory computer-readable medium with instructions stored thereon that, when executed by a processor, cause the processor to perform or control performance of operations comprising:
receiving data representing a virtual environment comprising a plurality of virtual regions, each virtual region being associated with a computational load and a memory load;
determining communication metrics between adjacent virtual regions of the plurality of virtual regions, wherein avatars within two adjacent virtual regions can move directly between the two adjacent virtual regions;
assigning each virtual region to a respective server of a plurality of servers, wherein the assigning is based on:
balancing the computational load and memory load among the plurality of servers, and
reducing communication metrics between virtual regions assigned to different servers;
refining the assignment of virtual regions to servers iteratively, such that virtual regions with dense interaction are grouped together on a common server to reduce inter-server communication;
replicating, based on the refined assignment, state data of virtual regions located at boundaries between server assignments to neighboring servers to enable migration of workload across servers; and
providing a distributed computing infrastructure for the virtual environment using the refined assignment, the distributed computing infrastructure comprising the plurality of servers and configured to simulate the virtual environment based on the assignment of virtual regions to the respective servers.

17. The non-transitory computer-readable medium of claim 16, wherein assigning each virtual region to the respective server is further based on predicting computational and memory loads for each virtual region based on historical telemetry data for the virtual environment.

18. The non-transitory computer-readable medium of claim 16, wherein determining the communication metrics comprises calculating a communication frequency between adjacent virtual regions based on player interactions and proximity of avatars within each of the adjacent virtual regions.

19. The non-transitory computer-readable medium of claim 16, wherein refining the assignment of virtual regions to servers comprises expanding one or more of the virtual regions using a greedy policy that prioritizes virtual regions with lower computational and memory loads for expansion.

20. The non-transitory computer-readable medium of claim 16, wherein assigning the virtual regions to servers is adjusted dynamically based on avatar density in the plurality of virtual regions and server resource availability.
